(19) United States
(12) Patent Application Publication
(10) Pub. No.: US 2025/0266223 A1
(43) Pub. Date: Aug. 21, 2025

(54) LIQUID CONTACTORS FOR POWER SYSTEMS

(71) Applicant: Caterpillar Inc., Peoria, IL (US)

(72) Inventor: Matthew Alex Hart, Oakham (GB)

(73) Assignee: Caterpillar Inc., Peoria, IL (US)

(21) Appl. No.: 18/581,546

(22) Filed: Feb. 20, 2024

(51) Int. Cl. H01H 29/04; H01H 29/26

(52) U.S. Cl. CPC H01H 29/04; H01H 29/26

(57) ABSTRACT

A contactor includes a housing having a chamber, a liquid media with a first fluid and a second fluid within the chamber and insoluble with each other, a conductive plate, a first terminal, a second terminal, and a mixing unit. The conductive plate is at an upper portion of the housing and is electrically connected to a lower portion of the housing. The first terminal is electrically connected with the chamber. The second terminal is connected to the lower portion. The mixing unit switches the liquid media between a mixed state and an unmixed state. In the mixed state, the fluids are mixed with each other to establish an electrical path between the terminals. In the unmixed state, the fluids are separated and immiscible with each other to disrupt the electrical path between the terminals.

### TECHNICAL FIELD

The present disclosure relates to contactors in electrical power systems of work machines. More particularly, the present disclosure relates to contactors having a liquid media applied to selectively establish and disrupt an electrical path between a power source and a load.

### BACKGROUND

Work machines, such as electrically powered work machines, generally include contactors to provide selective electrical coupling between a power source and a load. Contactors generally use significant amount of copper, which typically results in a commensurate increase in the cost of producing and maintaining the contactors. Further, during operation of copper based contactors, a passage of excess current through a copper coil of a contactor may damage the copper coil (and also the contactor) mostly needing extensive repairs and/or a full replacement of the contactor. Additionally, a useful life of copper based contactors are largely dependent upon a number of times the contactors are activated, and, therefore, the useful life of the contactors are limited.

United States Publication No.: 2006/017532 relates to a metallic contact switch comprising a housing defining a cavity, a conductive switching liquid in the cavity, switch contacts located in the cavity in electrical contact with the switching liquid in at least one switching state of the switch, an insulating fluid, and a Lorentz actuator comprising conductive actuating liquid located in the cavity and capable of movement in the cavity. The Lorentz actuator is mechanically coupled to the switching liquid to change the switching state of the switch.

### SUMMARY OF THE INVENTION

In one aspect, the disclosure is directed to a contactor for a power system. The contactor includes a housing, a liquid media, a conductive plate, a first terminal, a second terminal, and a mixing unit. The housing has a fluid containing chamber. The liquid media, including a first fluid and a second fluid, is contained within the fluid containing chamber. The first fluid and the second fluid are insoluble with each other. The conductive plate is positioned at an upper portion of the housing and is electrically connected to a lower portion of the housing. The first terminal is in electrical connection with the fluid containing chamber and the second terminal is in connection to the lower portion of the housing. The mixing unit switches the liquid media between a mixed state and an unmixed state. In the mixed state, the first fluid and the second fluid are mixed with each other to establish an electrical path between the first terminal and the second terminal through the liquid media. In the unmixed state, the first fluid and the second fluid are separated and immiscible with each other to disrupt the electrical path between the first terminal and the second terminal through the liquid media.

In another aspect, the disclosure relates to a power system for a work machine. The power system includes a controller and a power source to generate power for running a load. The power system includes a contactor to provide selective electrical coupling and electrical decoupling between the power source and the load in response to corresponding signals from the controller. The contactor includes a housing, a liquid media, a conductive plate, a first terminal, a second terminal, and a mixing unit. The housing has a fluid containing chamber. The liquid media includes a first fluid and a second fluid contained within the fluid containing chamber. The first fluid and the second fluid are insoluble with each other. Further, the conductive plate is positioned at an upper portion of the housing and is electrically connected to a lower portion of the housing. The first terminal is in electrical connection with the fluid containing chamber and the second terminal is in connection to the lower portion of the housing. The mixing unit switches the liquid media between a mixed state and an unmixed state. In the mixed state, the first fluid and the second fluid are mixed with each other to establish an electrical path between the first terminal and the second terminal through the liquid media, and, in the unmixed state, the first fluid and the second fluid are separated and immiscible with each other to disrupt the electrical path between the first terminal and the second terminal through the liquid media.

In yet another aspect, the disclosure is directed to a method of connecting a power source to a load. The method includes using a contactor to provide selective electrical coupling and electrical decoupling between the power source and the load in response to corresponding signals from a controller. The contactor includes a housing, a liquid media, a conductive plate, a first terminal, a second terminal, and a mixing unit. The housing has a fluid containing chamber. The liquid media includes a first fluid and a second fluid contained within the fluid containing chamber. The first fluid and the second fluid are insoluble with each other. Further, the conductive plate is positioned at an upper portion of the housing and is electrically connected to a lower portion of the housing. The first terminal is in electrical connection with the fluid containing chamber and the second terminal is in connection to the lower portion of the housing. The mixing unit switches the liquid media between a mixed state and an unmixed state. In the mixed state, the first fluid and the second fluid are mixed with each other to establish an electrical path between the first terminal and the second terminal through the liquid media, and, in the unmixed state, the first fluid and the second fluid are separated and immiscible with each other to disrupt the electrical path between the first terminal and the second terminal through the liquid media.

### BRIEF DESCRIPTION OF THE DRAWINGS

FIG. 1 is a schematic view of an exemplary power system, in accordance with an embodiment of the present disclosure;

FIG. 2 is a diagrammatic view of a contactor of the power system of FIG. 1, with the contactor in an unmixed state, in accordance with an embodiment of the present disclosure; and

FIG. 3 is another diagrammatic view of the contactor of the power system of FIG. 1, with the contactor in a mixed state, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1, 1″, 101 and 201, could refer to one or more comparable components used in the same and/or different depicted embodiments.

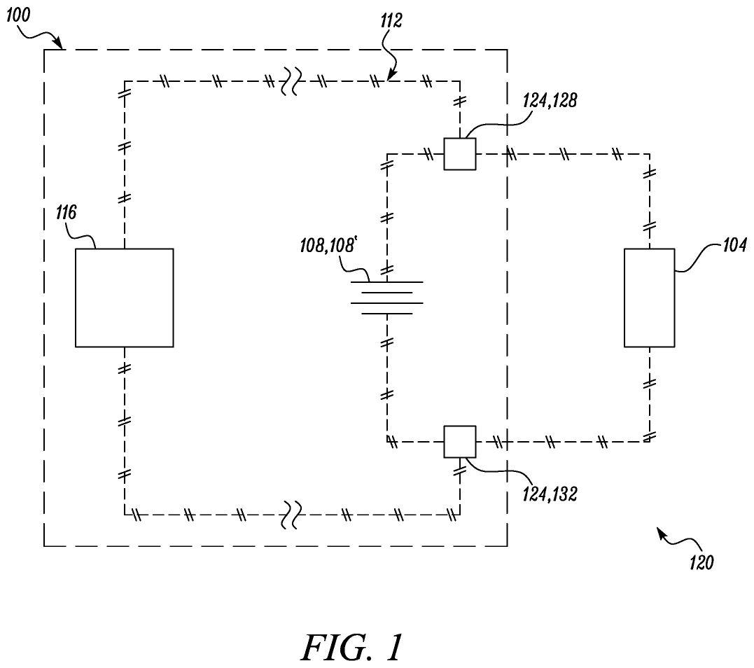

Referring to FIG. 1, an exemplary power system (e.g., a power system 100) is shown and described. The power system 100 may be applied in a work machine (e.g., an electrical work machine) (not shown) employable at a worksite. The power system 100 may help the work machine perform one or more activities, e.g., earthmoving, construction, road laying, etc., at the worksite. As an example, the work machine may be a mobile machine that may traverse between various locations of the worksite. The power system 100, however, may be contemplated and applied for various other types of machines, e.g., stationary work machines, such as generator sets, as well. Moreover, the power system 100 may be applied in various other environments and applications.

In some examples, the power system 100 may be applied to serve a load 104. As an example, the load 104 may be associated with the work machine and may represent one or more electrically operable devices or apparatuses of the work machine that may be manipulated or altered to perform one or more tasks. As an example, the tasks may help execute, at least in part, one or more of the aforesaid activities. In one example, said devices or apparatuses may include and/or correspond to electrical actuators or motors associated with an implement (e.g., a blade, a bucket, or a screed) (not shown) of the work machine that may be applied for engaging and/or altering earth. As another example, said devices or apparatuses may include and/or correspond to one or more electrical motors associated with one or more traction devices (not shown) of the work machine that may be used to move the work machine. Various such examples of the devices or apparatuses (i.e., the load) may be contemplated by those of skill in the art based on the present description. As a whole, the schematic view provided FIG. 1 may represent a work machine system 120.

With continued reference to FIG. 1, the power system 100 may include an electrical power source 108, which may include one or more batteries (e.g., see battery 108). In this regard, the electrical power source 108 may include a direct current (DC) battery, an alternating current (AC) grid connection, or the electrical power source 108 may include any other suitable power source based on its area of application. The electrical power source 108 may produce or generate electrical power for powering one or more of the machine functions, which may be exemplarily inclusive of the tasks performable by the load 104, may include machine motion (e.g., by providing power to the motors associated with the traction devices), and/or implement control (e.g., by providing power to the actuators associated with the implement). The power system 100 may also include a power supply circuit 112 to provide or supply the power from the electrical power source 108 to the load 104 for running the load 104 and thus potentially powering one or more of the aforesaid machine functions.

Furthermore, the power system 100 may include a controller 116. The controller 116 may be applied to control various aspects related to a working of the electrical power source 108, e.g., an activation and deactivation of the electrical power source 108 and/or a regulation of the electrical power supply from the electrical power source 108 to the load 104. In some embodiments, the controller 116 may form part of an existing control system, e.g., a Battery Management System (BMS) or an Electronic Control Module (ECM), of the work machine, or, alternatively, the controller 116 may be a standalone entity. As an example, the controller 116 may generate (e.g., selectively generate) signals to correspondingly initiate and/or halt the supply of electrical power from the electrical power source 108 to the load 104, e.g., to control a running of the load 104. In this regard, a signal generated by the controller 116 to initiate the supply of power from the electrical power source 108 to the load 104 may be referred to as an ‘initiation signal’ and a signal generated by the controller 116 to halt the supply of power from the electrical power source 108 to the load 104 may be referred to as a ‘halt signal’.

The power system 100 may also include one or more contactors 124, e.g., a first contactor 128 and a second contactor 132, as shown. The first contactor 128 and the second contactor 132 may be suitably electrically connected and integrated into the power supply circuit 112. The first contactor 128 and the second contactor 132 may be each in operable communication with the controller 116. By way of the operable communication between the controller 116 and the contactors 124, operations of the first contactor 128 and the second contactor 132 may be controlled by the controller 116. For example, the controller 116 may suitably control the contactors 124 to ensure that either the electrical power from the electrical power source 108 may be supplied to the load 104, or, alternatively, the electrical power from the electrical power source 108 may be restricted from supply to the load 104. In other words, both the first contactor 128 and the second contactor 132 may correspond to or include electrical contactors (e.g., electrically actuated contactors) that may serve to selectively route and sever the electrical connectivity between the electrical power source 108 and the load 104. As an example, one or more of the first contactor 128 and the second contactor 132 may be part of a pre-charge circuit of the power system 100.

In further detail, when the controller 116 may generate the initiation signal, a low voltage circuit (not shown) may produce and deliver a corresponding first voltage signal to the contactors 124 to shift the contactors 124 (e.g., simultaneously) to a first condition in which the contactors 124 may facilitate the supply of the electrical power from the electrical power source 108 to the load 104 to run the load 104. The contactors 124 may provide such electrical supply and/or electrical coupling between the electrical power source 108 and the load 104 in response to the initiation signal. Conversely, when the controller 116 may generate the halt signal, the low voltage circuit may produce and deliver a corresponding second voltage signal (different from the first voltage signal, e.g., zero voltage) to the contactors 124 to shift the contactors 124 (e.g., simultaneously) to a second condition in which the contactors 124 may restrict the electrical power from being supplied to the load 104 from the electrical power source 108. The contactors 124 may perform such restriction and/or provide electrical decoupling between the electrical power source 108 and the load 104 in response to the halt signal. Effectively, the contactors 124 may provide selective electrical coupling and electrical decoupling between the electrical power source 108 and the load 104 in response to corresponding signals from the controller 116.

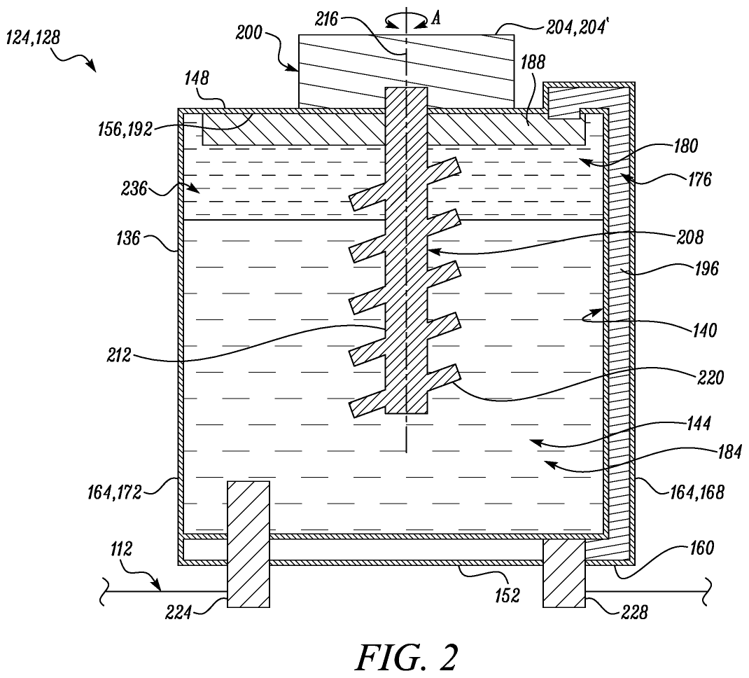

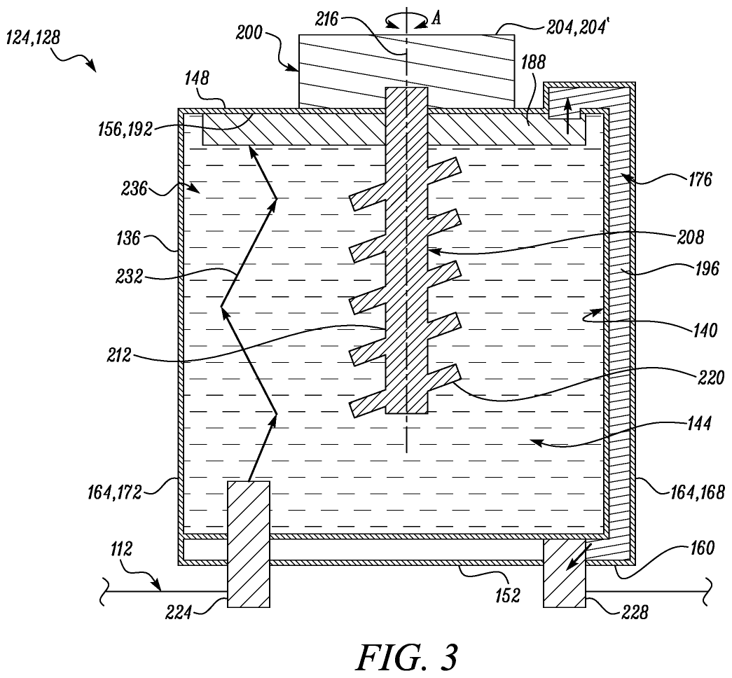

Further discussions in the present disclosure is generally directed towards the first contactor 128. Unless specified otherwise, those discussions may be suitably applied to the second contactor 132 as well, and the same may be contemplatable by someone skilled in the art based on the present disclosure. Wherever needed, however, reference to the second contactor 132 shall also be used. For ease, the first contactor 128 may be simply and/or interchangeably referred to as a contactor 128, hereinafter. Additionally, it may be noted that if the power system 100 (and thus the contactor 128) were applied in a mobile work machine, as exemplarily discussed above, the contactor 128 may be prone to tilting to various angles during operations and/or during a movement of the mobile work machine. However, for the purposes of the present disclosure, and for ease in discussions and referencing, aspects of the contactor 128 are described assuming the contactor 128 is oriented exemplarily upright (as is also illustrated in FIGS. 2 and 3), and, accordingly, relative terms such as ‘upper’ or ‘lower’ are used for describing various parts of the contactor 128. Such terms are used for illustrative or exemplary purposes only.

Referring to FIGS. 2 and 3, the contactor 128 may include a housing 136 with a fluid containing chamber 140. The fluid containing chamber 140 may hold or store a liquid media 144, as is exemplarily and diagrammatically shown in FIGS. 2 and 3. Although not limited, the housing 136 may include a cuboidal profile. In this regard, the housing 136 may define a top wall 148 and a bottom wall 152, as shown. The top wall 148 may define an upper portion 156 of the housing 136 and the bottom wall 152 may define a lower portion 160 of the housing 136. Further, the housing 136 may define one or more sidewalls 164 extending from the top wall 148 to the bottom wall 152.

As an example, the sidewalls 164 may correspond to or include a first sidewall 168 and a second sidewall 172, as shown. Additional sidewalls may be contemplated. Further, the top wall 148, the bottom wall 152, and the sidewalls 164 (e.g., the first sidewall 168 and the second sidewall 172) may together surround and define the fluid containing chamber 140 within the contactor 128. As an example, a profile of fluid containing chamber 140 defined by the sidewalls 164, the top wall 148, and the bottom wall 152, may be cuboidal as well, to comport to the overall profile of the housing 136. Further, the contactor 128 may include an electrically insulated passage 176 extending along one of the sidewalls 164 (e.g., the first sidewall 168). In some embodiments, the housing 136 or the sidewalls 164, top wall 148, and the bottom wall 152, defining the housing 136, may be formed from an electrically insulated material, such as a high-grade plastic or a polymeric material.

The liquid media 144 contained or held within the fluid containing chamber 140 of the contactor 128 may include a first fluid 180 and a second fluid 184. The first fluid 180 may be an electrically inert fluid or an electrically insulative fluid while the second fluid 184 may be an electrically conductive fluid. The first fluid 180 and the second fluid 184 may be insoluble with each other and each of them may exhibit inherent properties (e.g., hydrophobic property of one fluid if the other fluid includes water) that may keep them separated from (and immiscible relative to) each other, e.g., when the liquid media 144 is at rest or no agitation is induced into the liquid media 144.

During operations of the contactor 128, the liquid media 144 (e.g., the first fluid 180 and the second fluid 184) may be switched (e.g., repeatedly switched) between a mixed state (see state of liquid media 144 in FIG. 3) and an unmixed state (see state of liquid media 144 in FIG. 2) such that the contactor 128 can respectively shift between the first condition and the second condition of the contactor 128. In the mixed state, the first fluid 180 may be mixed with the second fluid 184 (without being dissolved into the second fluid), and, in the unmixed state, the first fluid 180 may be separated and/or segregated from the second fluid 184. Aspects related to a manner in which such shift between the first condition and the second condition is attained is discussed later.

In some embodiments, one of the first fluid 180 and the second fluid 184 may have a first density and the other of the first fluid 180 and the second fluid 184 may have a second density. The second density may be different from the first density, e.g., with one being lesser than the other. In that manner, one of the first fluid 180 and the second fluid 184 may float above the other of the first fluid 180 and the second fluid 184 in the unmixed state of the liquid media 144. According to an aspect of the present disclosure, the first fluid 180 or the electrically insulative fluid may have a first density while the second fluid 184 or the electrically conductive fluid may have a second density. As an example, the first density may be lesser than the second density, and, in such a case (in the unmixed state of the liquid media 144) the first fluid 180 may float above or over the second fluid 184. In other words, the electrically insulative fluid may float above the electrically conductive fluid in the fluid containing chamber 140, while the electrically conductive fluid may settle below the electrically insulative fluid in the fluid containing chamber 140.

In some embodiments, a volume of the second fluid 184 or the electrically conductive fluid in the fluid containing chamber 140 may be larger than a volume of the first fluid 180 or the electrically insulative fluid in the fluid containing chamber 140. In some embodiments, the volume of the second fluid 184 or the electrically conductive fluid may be between 60% to 80% of a total volume defined combinedly by the liquid media 144 (e.g., a total volume defined by the electrically conductive fluid and the electrically insulative fluid, or, in other words, a total volume defined by the first fluid 180 and the second fluid 184). In some embodiments, the total volume defined by the liquid media 144 or combinedly by the first fluid 180 and the second fluid 184 may take up to 90% to 98% of an internal volume of the fluid containing chamber 140. In some embodiments, a depth of the first fluid 180 in the fluid containing chamber 140 is at least 10 (ten) millimeter (mm) and which may be needed to exemplarily insulate 600 (six hundred) Volts. As an example, the first fluid 180 may include on or more of liquid helium, liquid neon, silicone oils, and the like fluids, and the second fluid 184 may include water, mercury, and the like fluids. These values are provided for illustrative purposes only.

The contactor 128 may include a conductive plate 188 (e.g., an electrically conductive plate). The conductive plate 188 may be positioned at the upper portion 156, e.g., at a roof 192, of the housing defined by the top wall 148 of the housing 136. The conductive plate 188 may be in contact with the liquid media 144. For example, in the mixed state (see FIG. 3) of the liquid media 144, the conductive plate 188 may be in contact with a mixed form of the liquid media 144. Conversely, in the unmixed state (see FIG. 2), the conductive plate 188 may be in contact with the first fluid 180 or the electrically insulative fluid of the liquid media 144 as the overall volume of the liquid media 144 may remain unchanged. The contact of the conductive plate 188 with the first fluid 180 in the unmixed state of the contactor 128 is because the first fluid 180 floats above the second fluid 184 in the unmixed state of the contactor 128. In effect, in the unmixed state of the liquid media 144, the conductive plate 188 may be away from contact with the second fluid 184 (or the electrically conductive fluid) and thus the conductive plate 188 may be insulated from the second fluid 184 (or the electrically conductive fluid) by way of the inert, first fluid 180 interfaced between the second fluid 184 and the conductive plate 188.

According to some embodiments, the conductive plate 188 may be electrically connected to the lower portion 160 of the housing 136. To this end, the contactor 128 may include a conductive link 196 (e.g., a copper wire, and/or the like article). The conductive link 196 may be electrically connected to the conductive plate 188 and may be routed, at least in part, through the electrically insulated passage 176 of the housing 136 to reach up to the lower portion 160 of the housing 136. Effectively, the conductive link 196 may extend from the upper portion 156 or the top wall 148 of the housing 136 to the lower portion 160 or to the bottom wall 152 of the housing 136.

The contactor 128 may further include a mixing unit 200. The mixing unit 200 may be applied to switch the liquid media 144 between the mixed state and the unmixed state. To this end, the mixing unit 200 may be electrically operable and may be selectively changeable between an active state and an inactive state. In the active state, the mixing unit 200 may mix the first fluid 180 with the second fluid 184, switching the liquid media 144 to the mixed state, while, in the inactive state, the mixing unit 200 may facilitate to bring the first fluid 180 and the second fluid 184 at rest with respect to each other, thus switching the liquid media 144 to the unmixed state.

The mixing unit 200 may include an actuator 204, which may include an electrically operated motor 204. The actuator 204 may receive the first voltage signal in response to corresponding signals from the controller 116 to either run the mixing unit 200 and switch the liquid media 144 to the mixed state (see FIG. 3) or stop the mixing unit 200 to switch the liquid media 144 to the unmixed state (see FIG. 2). Further, the mixing unit 200 may include a mixer shaft 208 drivable by the actuator 204. The mixer shaft 208 may include a shaft portion 212 defining a longitudinal axis 216. The mixer shaft 208 may also include multiple stirrer blades, e.g., see stirrer blades 220, which may be positioned (e.g., rotatably or helically arrayed) around the shaft portion 212 and about the longitudinal axis 216. In an assembly of the mixing unit 200 with the housing 136, the mixer shaft 208 (and particularly the stirrer blades 220) may come into contact and engage with the liquid media 144 so as to switch the liquid media 144 between the mixed state and the unmixed state.

The mixer shaft 208 (i.e., both the shaft portion 212 and the stirrer blades 220) may be formed from an electrically insulated material and may extend into the fluid containing chamber 140 such that, in the unmixed state of the liquid media 144, the stirrer blades 220 may come into contact with both the first fluid 180 and the second fluid 184. When the mixer shaft 208 may be driven by the actuator 204 (e.g., upon the actuator 204 receiving a corresponding actuation signal or initiation signal from the controller 116), the mixer shaft 208 may induce a rotary swirling motion into the liquid media 144 to mix the first fluid 180 with the second fluid 184 and switch the liquid media 144 to the mixed state. For the purposes of the present disclosure, the electrically insulated material associated with the mixer shaft 208 may be referred to as a ‘first electrically insulated material’ and the electrically insulated material associated with the housing 136 (or the sidewalls 164, the top wall 148, and the bottom wall 152 of the housing 136) may be referred to as a ‘second electrically insulated material’. Although not limited, one or both the first electrically insulated material and the second electrically insulated material may include high-grade plastic or polymer.

Further, the contactor 128 may include a first terminal 224 and a second terminal 228. The first terminal 224 and the second terminal 228 may be electrical terminals of the contactor 128. Exemplarily, and in case of the first contactor 128, the first terminal 224 may be configured to receive power from the electrical power source 108 and the second terminal 228 may be configured to deliver the power to the load 104. A corresponding functionality of a first terminal and a second terminal associated with the second contactor 132 may be contemplated by someone of skill in the art based on the present disclosure. Although not limited, both the first terminal 224 and the second terminal 228 may be connected and/or positioned at the lower portion 160, e.g., on/at the bottom wall 152, of the housing 136, as shown. Other positions of the first terminal 224 and the second terminal 228 may be contemplated.

The first terminal 224 may be in electrical connection with the fluid containing chamber 140 (e.g., in electrical contact with the liquid media 144 held or stored within the fluid containing chamber 140). The second terminal 228 may be in electrical connection to the lower portion 160 of the housing 136, and, more particularly, the second terminal 228 may be in electrical connection with the conductive link 196 which may be electrically coupled to and may extend from the conductive plate 188. Therefore, the second terminal may be electrically coupled to the conductive plate 188 as the conductive link 196, routed through the electrically insulated passage 176, may extend from the conductive plate 188 and reach up to the lower portion 160 or to the second terminal 228 (that is to say that the conductive link 196 may be electrically connected between the conductive plate 188 and the second terminal 228).

### INDUSTRIAL APPLICABILITY

An exemplary method of connecting the electrical power source 108 to the load 104 includes using the contactor 128, as described above, to provide selective electrical coupling and electrical decoupling between the electrical power source 108 and the load 104 in response to corresponding signals (e.g., initiation signal and/or halt signals) from the controller 116.

Prior to the start of working of the power system 100, the electrical power source 108 and the contactor 128 may be non-functional and the liquid media 144 stored or held within the contactor 128 may be at rest, i.e., a condition in which the liquid media 144 is not induced with any motion, agitation, or stirring, and thus may be in the unmixed state. As described above, in the unmixed state, the first fluid 180 (or the electrically insulative fluid) may be separated from the second fluid 184 (or the electrically conductive fluid), and with the first fluid 180 being exemplarily lighter in density than the second fluid 184, the first fluid 180 (or the electrically insulative fluid) may float above the second fluid 184 to form an inert layer or an insulated layer 236 between the second fluid 184 and the conductive plate 188, thus keeping the conductive plate 188 and the second fluid 184 electrically insulated from each other.

In effect, while the conductive plate 188 may be in contact with and be electrically coupled to the second terminal 228 through the conductive link 196, and, also, the second fluid 184 may be electrically coupled to the first terminal 224, in the unmixed state, the first fluid 180 floating above the second fluid 184 may act as the insulated layer 236 between the conductive plate 188 and the second fluid 184, thus also insulating the first terminal 224 from the second terminal 228 and effectively severing any electrical connectivity between the electrical power source 108 and the load 104.

As the power system 100 may start operation, the controller 116 may generate the initiation signal urging the low voltage circuit to produce and deliver the first voltage signal to the contactor 128 to move the contactor 128 to the first condition (e.g., the condition in which the contactor 128 may facilitate the supply of the electrical power from the electrical power source 108 to the load 104). In this regard, the first voltage signal may be received by the mixing unit 200 of the contactor 128, and, more particularly, by the actuator 204 (or the electrically operated motor 204′) of the mixing unit 200. Upon receipt of the first voltage signal by the actuator 204, the actuator 204 may be powered to provide motive power to the mixer shaft 208, in turn rotating the mixer shaft 208 about the longitudinal axis 216. Said rotation causes the stirrer blades 220 to rotate as well (see exemplary direction of the rotation, A, FIGS. 2 and 3), inducing the rotary swirling motion into the liquid media 144, thereby mixing the first fluid 180 with the second fluid 184 and switching the liquid media 144 to the mixed state.

In the mixed state, the liquid media 144 is agitated and stirred (e.g., violently), urging molecules of the first fluid 180 and second fluid 184 to mingle significantly with each other (without one dissolving into the other), causing the insulated layer 236 formed by the first fluid 180 to lose integrity and become practically non-existent in the fluid containing chamber 140. As a result, swirling molecules of the second fluid 184 may reach up to the conductive plate 188 and help form or establish an electrical path 232 (which may be an arbitrary or an irregular path) between the first terminal 224 and the conductive plate 188 (and thus between the first terminal 224 and the second terminal 228) through the liquid media 144, thereby ensuring a passage of power from the electrical power source 108 to the load 104. As and when the controller 116 may generate the halt signal, the second voltage signal (which may include zero voltage) may be delivered to the contactor 128 to move the contactor 128 to the second condition, thus returning the liquid media 144 to the unmixed state.

In brevity, in the mixed state, the first fluid 180 and the second fluid 184 are mixed with each other to establish the electrical path 232 (see FIG. 3) between the first terminal 224 and the second terminal 228 through the liquid media 144. Conversely, in the unmixed state, the first fluid 180 and the second fluid 184 may be separated and immiscible with each other to disrupt the electrical path 232 between the first terminal 224 and the second terminal 228 through the liquid media 144. When switching back to the unmixed state of the liquid media 144, each of the first fluid 180 and the second fluid 184 may regain their integrity and thus return to the state (e.g., the initial, unmixed state) in which the first fluid 180 may float above or over the second fluid 184 and act as the insulated layer 236 between the second fluid 184 and the conductive plate 188, and thus between the first terminal 224 and the second terminal 228.

The volume of the second fluid 184 being exemplarily higher than the first fluid 180 (e.g., between 60% to 80% of a total volume defined combinedly by the liquid media 144) increases the chances of the molecules of the second fluid 184 to reach up to the conductive plate 188 in the mixed state of the liquid media 144, thus helping the second fluid 184 to bridge and establish the electrical path 232 with relative ease in the mixed state of the liquid media 144. On the other hand, the relatively lower volume of the first fluid 180 ensures that the contactor 128 remains functional (i.e., to disrupt the electrical path 232) in the unmixed state, e.g., even when the contactor 128 is made to tilt up to a certain degree to a vertical. The above numbers can change based on the nature of the application of the contactor 128 and is thus illustrative and non-limiting.

The use of the liquid media 144 improves the overall useful life of the contactor 128 in comparison to conventional contactors. Moreover, the liquid media 144 mitigates chances of faults and/or any ensuing contactor damage compared to mechanically connected (and/or actuated) electrical devices. Prolonged periods of operation or excessive operation may at best wear out the actuator 204 or the mixing unit 200, which is easier and more economical to repair and/or replace than to repair and/or replace an entire contactor, thus making the contactor 128 more cost effective to use. Additionally, as the contactor 128 may use minimum amount of copper, contactor production costs can be kept under control and copper element wear and/or repairs and replacement may be altogether avoided.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A contactor for a power system, the contactor comprising:
a housing having a fluid containing chamber;
a liquid media including a first fluid and a second fluid contained within the fluid containing chamber, the first fluid and the second fluid being insoluble with each other;
a conductive plate positioned at an upper portion of the housing and being electrically connected to a lower portion of the housing;
a first terminal in electrical connection with the fluid containing chamber and a second terminal in connection to the lower portion of the housing; and
a mixing unit to switch the liquid media between a mixed state and an unmixed state, wherein
in the mixed state, the first fluid and the second fluid are mixed with each other to establish an electrical path between the first terminal and the second terminal through the liquid media, and
in the unmixed state, the first fluid and the second fluid are separated and immiscible with each other to disrupt the electrical path between the first terminal and the second terminal through the liquid media.

2. The contactor of claim 1, wherein
one of the first fluid and the second fluid has a first density and the other of the first fluid and the second fluid has a second density,
the first density is lesser than the second density to facilitate one of the first fluid and the second fluid to float above the other of the first fluid and the second fluid in the unmixed state of the liquid media, and
in the unmixed state of the liquid media, one of the first fluid and the second fluid, separated from the other of the first fluid and the second fluid, forms an insulated layer in the fluid containing chamber to disrupt the electrical path through the liquid media.

3. The contactor of claim 1, wherein
the first fluid is an electrically insulative fluid and the second fluid is an electrically conductive fluid, and
a volume of the electrically conductive fluid in the fluid containing chamber is larger than a volume of the electrically insulative fluid in the fluid containing chamber.

4. The contactor of claim 3, wherein the volume of the electrically conductive fluid is between 60% to 80% of a total volume defined combinedly by the electrically conductive fluid and the electrically insulative fluid.

5. The contactor of claim 3, wherein
the electrically insulative fluid has a first density and the electrically conductive fluid has a second density, the first density is lesser than the second density such that in the unmixed state of the liquid media:
the electrically insulative fluid floats above the electrically conductive fluid in the fluid containing chamber and the electrically conductive fluid settles below the electrically insulative fluid in the fluid containing chamber, and
the electrically insulative fluid forms an insulated layer in the fluid containing chamber, between the electrically conductive fluid and one of the first terminal or the second terminal, to disrupt the electrical path through the liquid media.

6. The contactor of claim 1, wherein the mixing unit is selectively changeable between an active state and an inactive state, wherein,
in the active state, the mixing unit mixes the first fluid with the second fluid, switching the liquid media to the mixed state, and
in the inactive state, the mixing unit facilitates to bring the first fluid and the second fluid at rest with respect to each other, switching the liquid media to the unmixed state.

7. The contactor of claim 6, wherein the mixing unit includes an actuator and a mixer shaft drivable by the actuator, the mixer shaft including a plurality of stirrer blades to engage with the liquid media, wherein,
when the mixer shaft is driven by the actuator upon the actuator receiving a corresponding actuation signal from a controller, the mixer shaft induces a rotary swirling motion into the liquid media to mix the first fluid with the second fluid and switch the liquid media to the mixed state, and
the mixer shaft is formed from a first electrically insulated material and extends into the fluid containing chamber such that, in the unmixed state of the liquid media, the plurality of stirrer blades come into contact with both the first fluid and the second fluid.

8. The contactor of claim 1, wherein the housing is formed from a second electrically insulated material.

9. The contactor of claim 1 further comprising a conductive link electrically connected between the conductive plate and the second terminal, wherein the housing defines an electrically insulated passage extending along a sidewall of the housing to route, at least in part, the conductive link from the conductive plate to the second terminal.

10. A power system for a work machine, the power system comprising:
a controller;
a power source to generate power for running a load; and
a contactor to provide selective electrical coupling and electrical decoupling between the power source and the load in response to corresponding signals from the controller, the contactor including:
a housing having a fluid containing chamber;
a liquid media including a first fluid and a second fluid contained within the fluid containing chamber, the first fluid and the second fluid being insoluble with each other;
a conductive plate positioned at an upper portion of the housing and being electrically connected to a lower portion of the housing;
a first terminal in electrical connection with the fluid containing chamber and a second terminal in connection to the lower portion of the housing; and
a mixing unit to switch the liquid media between a mixed state and an unmixed state, wherein
in the mixed state, the first fluid and the second fluid are mixed with each other to establish an electrical path between the first terminal and the second terminal through the liquid media, and
in the unmixed state, the first fluid and the second fluid are separated and immiscible with each other to disrupt the electrical path between the first terminal and the second terminal through the liquid media.

11. The power system of claim 10, wherein
one of the first fluid and the second fluid has a first density and the other of the first fluid and the second fluid has a second density,
the first density is lesser than the second density to facilitate one of the first fluid and the second fluid to float above the other of the first fluid and the second fluid in the unmixed state of the liquid media, and
in the unmixed state of the liquid media, one of the first fluid and the second fluid, separated from the other of the first fluid and the second fluid, forms an insulated layer in the fluid containing chamber to disrupt the electrical path through the liquid media.

12. The power system of claim 10, wherein
the first fluid is an electrically insulative fluid and the second fluid is an electrically conductive fluid, and
a volume of the electrically conductive fluid in the fluid containing chamber is larger than a volume of the electrically insulative fluid in the fluid containing chamber.

13. The power system of claim 12, wherein the volume of the electrically conductive fluid is between 60% to 80% of a total volume defined combinedly by the electrically conductive fluid and the electrically insulative fluid.

14. The power system of claim 12, wherein
the electrically insulative fluid has a first density and the electrically conductive fluid has a second density, the first density is lesser than the second density such that in the unmixed state of the liquid media:
the electrically insulative fluid floats above the electrically conductive fluid in the fluid containing chamber and the electrically conductive fluid settles below the electrically insulative fluid in the fluid containing chamber, and
the electrically insulative fluid forms an insulated layer in the fluid containing chamber, between the electrically conductive fluid and one of the first terminal or the second terminal, to disrupt the electrical path through the liquid media.

15. The power system of claim 10, wherein the mixing unit is selectively changeable between an active state and an inactive state, wherein,
in the active state, the mixing unit mixes the first fluid with the second fluid, switching the liquid media to the mixed state, and
in the inactive state, the mixing unit facilitates to bring the first fluid and the second fluid at rest with respect to each other, switching the liquid media to the unmixed state.

16. The power system of claim 15, wherein the mixing unit includes an actuator and a mixer shaft drivable by the actuator, the mixer shaft including a plurality of stirrer blades to engage with the liquid media, wherein,
when the mixer shaft is driven by the actuator upon the actuator receiving a corresponding actuation signal from the controller, the mixer shaft induces a rotary swirling motion into the liquid media to mix the first fluid with the second fluid and switch the liquid media to the mixed state, and
the mixer shaft is formed from a first electrically insulated material and extends into the fluid containing chamber such that, in the unmixed state of the liquid media, the plurality of stirrer blades come into contact with both the first fluid and the second fluid.

17. The power system of claim 10, wherein the housing is formed from a second electrically insulated material.

18. The power system of claim 10 further comprising a conductive link electrically connected between the conductive plate and the second terminal, wherein the housing defines an electrically insulated passage extending along a sidewall of the housing to route, at least in part, the conductive link from the conductive plate to the second terminal.

19. A method of connecting a power source to a load, the method comprising:
using a contactor to provide selective electrical coupling and electrical decoupling between the power source and the load in response to corresponding signals from a controller, the contactor including:
a housing having a fluid containing chamber;
a liquid media including a first fluid and a second fluid contained within the fluid containing chamber, the first fluid and the second fluid being insoluble with each other;
a conductive plate positioned at an upper portion of the housing and being electrically connected to a lower portion of the housing;
a first terminal in electrical connection with the fluid containing chamber and a second terminal in connection to the lower portion of the fluid containing chamber; and
a mixing unit to switch the liquid media between a mixed state and an unmixed state, wherein
in the mixed state, the first fluid and the second fluid are mixed with each other to establish an electrical path between the first terminal and the second terminal through the liquid media, and
in the unmixed state, the first fluid and the second fluid are separated and immiscible with each other to disrupt the electrical path between the first terminal and the second terminal through the liquid media.

20. The method of claim 19, wherein
one of the first fluid and the second fluid has a first density and the other of the first fluid and the second fluid has a second density,
the first density is lesser than the second density to facilitate one of the first fluid and the second fluid to float above the other of the first fluid and the second fluid in the unmixed state of the liquid media, and
in the unmixed state of the liquid media, one of the first fluid and the second fluid, separated from the other of the first fluid and the second fluid, forms an insulated layer in the fluid containing chamber to disrupt the electrical path through the liquid media.
